(19) United States
(12) Patent Application Publication
(10) Pub. No.: US 2009/0188630 A1
(43) Pub. Date: Jul. 30, 2009

(54) Laminated Microcapsule Sheet Producing Apparatus

(75) Inventors: Kanji Takada, Kyoto-shi (JP); Takashi Iwade, Shiga (JP); Shinya Izumida, Shiga (JP); Masamichi Yamashita, Shiga (JP); Kiyohito Yamamoto, Shiga (JP)

Correspondence Address: GLOBAL IP COUNSELORS, LLP, 1233 20TH STREET, NW, SUITE 700, WASHINGTON, DC, 20036-2680, US

(73) Assignees: KANJI TAKADA, KYOTO-SHI (JP); TORAY ENGINEERING CO., LTD., Tokyo (JP)

(21) Appl. No.: 12/162,024

(22) PCT Filed: Feb. 2, 2007
(86) PCT No.: PCT/JP2007/051784

§ 371 Date: Dec. 12, 2008

(30) Foreign Application Priority Data
Feb. 6, 2006 (JP) 2006-028770

(51) Int. Cl. B65C 11/02

(52) U.S. Cl. 156/384

(57) ABSTRACT

An apparatus capable of producing a laminated microcapsule sheet through transferring with high productivity of a drug solution of high viscosity accurately as much as a given weight while avoiding run-off from an enteric layer. There is provided an apparatus comprising edible film holding means (1) for holding an edible film (4); solution transfer printing means (2) equipped with multiple needles (22) for transfer printing of a solution containing any of materials; and a pallet (3) for applying of the solution containing any of materials to the solution transfer printing means (2).

### TECHNICAL FIELD

The present invention relates to an apparatus for production of a laminated microcapsule sheet. More particularly, the present invention relates to an apparatus for production of a laminated microcapsule sheet which is suitable for a case where a laminated microcapsule sheet is adhered to an intestinal mucosa and drug is directly administered to the intestinal mucosa.

### BACKGROUND ART

A conventional laminated microcapsule sheet is produced by applying enteric layers each having a diameter of equal to or less than at least 1 mm at multiple parts on an edible film using an ink jet printing process, by applying a drug layer on the enteric layer, and by applying a barrier layer which is not dissolved in stomach nor bowel on the drug layer.

The enteric layer material, drug layer material, and barrier layer material are material in solution condition (hereinafter, referred to as drug solution) containing an adequate solvent.

But, the ink jet printing process has a disadvantage such that discharging of drug solution having high viscosity of more than 20 cp is difficult.

On the other hand, a printing process such as gravure printing and the like, has a disadvantage such that drug is difficult to be adhered on the enteric layer without run off because the drug adhered is not adsorbed on the enteric layer.

Further, as is disclosed in a patent document 1, technique for adhering solution to a needle, and for transfer printing the solution at a location for repair, is put in practical use, as a repairing device for a color filter.

Patent Document 1: Japanese Patent Laid-Open Tokukai 2004-205912 (JP 2004-205912 A)

### DISCLOSURE OF THE INVENTION

### Problems to be Solved by the Invention

The process for detecting location of one needle and for adhering solution is good for repairing. But, a disadvantage arises in that productivity is low for applying to an apparatus for production of a laminated microcapsule sheet.

When multiple needles are employed, another disadvantage arises in that controlling of a transfer printing amount is difficult.

The present invention was made in view of the above problems.

It is an object of the present invention to provide an apparatus which can produce a laminated microcapsule sheet by transfer printing drug solution having high viscosity, with a predetermined weight with accuracy, without run off, and with high productivity.

### Means for Solving the Problems

An apparatus for production of a laminated microcapsule sheet according to the present invention comprises edible film holding means for holding an edible film, solution transfer printing means having multiple needles for transfer printing a solution containing any of materials, and a pallet for adhering the solution containing any of materials to the solution transfer printing means.

It is preferable that weight measuring means is provided to at least one of the edible film holding means, the solution transfer printing means, and the pallet. In this case, although it is difficult that multiple needles are adhered solution perfectly uniformly, entire solution amount transfer printed can be measured.

For microcapsule drug products produced by the apparatus for production of a laminated microcapsule sheet according to the present invention, multiple microcapsules (for example, several hundreds to several tens thousand of microcapsules) are drunk at one time. Therefore, dosing amount is got control over by getting control over the entire solution amount of the microcapsules transfer printed at one time.

It is also preferable that at least one of the solution transfer printing means and edible film holding means is elastically supported. In this case, although height of enteric layers on an edible film are not uniform height, variation in adhered amount is prevented from occurrence. When the solution transfer printing means is elastically supported, needles may be elastically supported individually, or needles may be elastically supported by every group among multiple groups.

It is also preferable that solution level control means for controlling a solution level of the pallet is further provided. In this case, change in solution amount which is adhered to the needles is reduced by controlling the solution level of the pallet which is used for adhering the solution to the needles. When the solution has high viscosity, controlling of the solution level is realized with high accuracy by flattening the solution surface by scanning the solution surface with a squeegee. Wherein, the squeegee is a plate made of a material, to which the solution is hardly adhered, such as fluorocarbon resin, ceramics or the like. It is possible that a composition for positioning the tip of the needles corresponding to the solution level is employed.

It is preferable that weight measuring means provided at least one of the edible film holding means, the solution transfer printing means, and the pallet, and solution level control means for controlling the solution level of the pallet are further provided, and that adhesion amount control means for controlling an amount of the solution, which is to be adhered to the solution transfer printing means, based upon a weight measurement signal output from the weight measuring means, is further provided. In this case, targeted solution adhesion amount can be realized by controlling the solution level of the pallet, which is used for adhesion of the solution to the needles, and by changing the solution adhesion amount from the pallet to the needles, for example, by the adhesion amount control means based upon the weight measuring signal output from the weight control means.

An apparatus for production of a laminated microcapsule sheet according to the present invention comprises edible film holding means for holding an edible film, solution transfer printing means having multiple needles for transfer printing solution containing any of materials, and a spin coater for adhering the solution containing any of materials to the solution transfer printing means.

### EFFECTS OF THE INVENTION

The apparatus for production of a laminated microcapsule sheet according to the present invention can easily apply solution even when the solution has high viscosity which cannot be discharged by a conventional ink jet printing process. The apparatus can easily apply solution having high surface tension, especially water soluble drug solution for biological use, which solution is difficult to be discharged by a conventional ink jet printing process. Consequently, various laminated microcapsule sheets can easily be produced with accuracy, the laminated microcapsule sheet being suitable for adhering to an intestinal mucosa so as to directly dose drug to the intestinal mucosa.

The apparatus for production of a laminated microcapsule sheet according to the present invention can improve productivity because a great number of dots of drug solution can be formed on an edible film with one processing, consequently cost can be reduced.

### BRIEF DESCRIPTION OF THE DRAWINGS

FIG. 1 is a schematic view illustrating an embodiment of an apparatus for production of a laminated microcapsule sheet according to the present invention;

FIG. 2 is a schematic view illustrating a condition where a solution transfer printing apparatus is positioned just above a pallet;

FIG. 3 is a schematic view illustrating a condition where a needle member is dipped in drug solution so as to supply the drug solution to the needle member;

FIG. 4 is a schematic view illustrating a condition where a solution transfer printing apparatus is elevated in which drug solution is supplied to the needle member;

FIG. 5 is a schematic view illustrating a condition where drug solution is adhered to a tip of a needle member;

FIG. 6 is a schematic view illustrating a condition where drug solution adhered on a tip of a needle member is transfer printing to an edible film;

FIG. 7 is a schematic view illustrating a condition where drug solution remains on an edible film in a dotted pattern; and

FIG. 8 is a schematic view illustrating a condition where a solution transfer printing apparatus is positioned just above a spin coater.

### DESCRIPTION OF THE REFERENCE

1 edible film holding apparatus
2 solution transfer printing apparatus
3 pallet
4 edible film
5 drug solution
6 weight measuring apparatus
7 spin coater

### BEST MODE FOR CARRYING OUT THE INVENTION

Hereinafter, referring to the attached drawings, we explain embodiments of an apparatus for production of a laminated microcapsule sheet according to the present invention, in detail.

FIG. 1 is a schematic view illustrating an embodiment of an apparatus for production of a laminated microcapsule sheet according to the present invention.

The apparatus for production of a laminated microcapsule sheet comprises an edible film holding apparatus 1 for holding an edible film, a solution transfer printing apparatus 2 having multiple needles for transfer printing a solution containing any of materials, and a pallet 3 for adhering the solution containing any of materials to the solution transfer printing apparatus 2.

The edible film holding apparatus 1 has a base member 11, a supporting member 12, and an elastically supporting member 13 for elastically supporting the supporting member 12 above the base member 11, so that an edible film 4 is elastically supported on the supporting member 12.

The pallet 3 has a concave section for housing a solution containing any of materials (hereinafter, referred to as drug solution). The pallet 3 is supported by the weight measuring apparatus 6, so that measuring by the weight measuring apparatus 6 is carried out so as to output a weight measurement signal.

The solution transfer printing apparatus 2 has a main body member 21 having a predetermined planar shape, multiple needle members 22 provided to the under surface of the main body member 21 projecting downwardly, an X-axis driving mechanism 23 for moving the main body member 21 to and fro between a position above the edible film 4 and a position above the pallet 3, and a Z-axis driving mechanism 24 for moving the main body member 21 up and down at a location corresponding to the edible film 4, or at a location corresponding to the pallet 3. The planar shape and size of the main body member 21 can be selected corresponding to the size of the edible film 4. The number, interval and the like of the needle members 22 can be selected corresponding to a required microcapsule density or the like.

A controller (not illustrated) for controlling the X-axis driving mechanism 23 and the Z-axis driving mechanism 24, is further provided, the controller receiving the weight measurement signal or the like as an input signal.

Operations of the apparatus for production of a laminated microcapsule sheet having the above arrangement, is described.

Set up for production of a laminated microcapsule sheet is finished by supporting an edible film 4 on the supporting member 12 of the edible film holding apparatus 1, and by housing drug solution 5 in the concave section of the pallet 3.

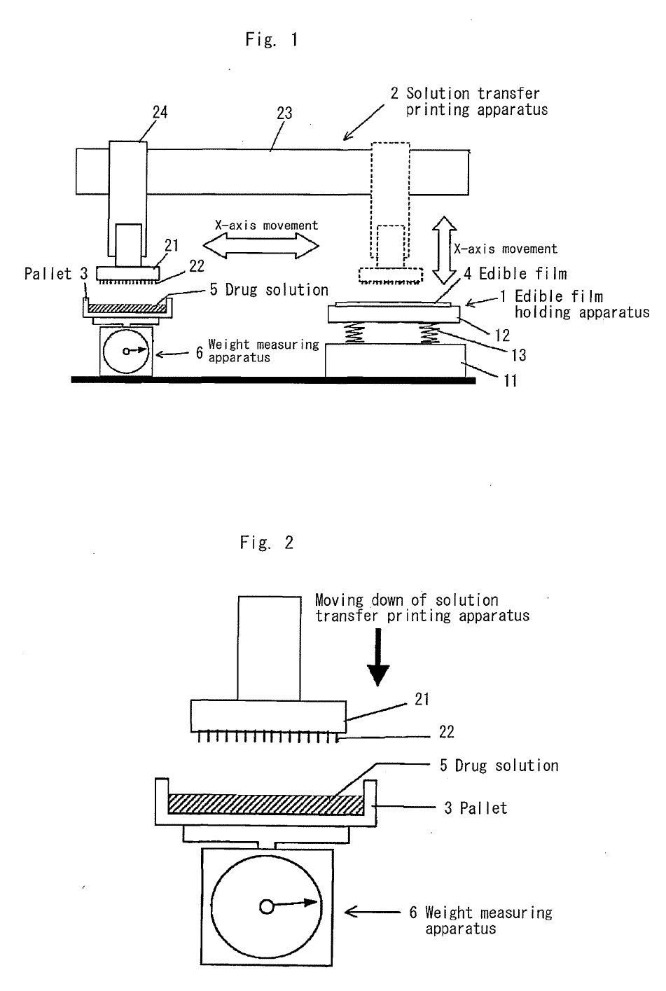

After the set up has finished, the solution transfer printing apparatus 2 is positioned just above the pallet 3 by the X-axis driving mechanism 23 (refer to FIG. 2).

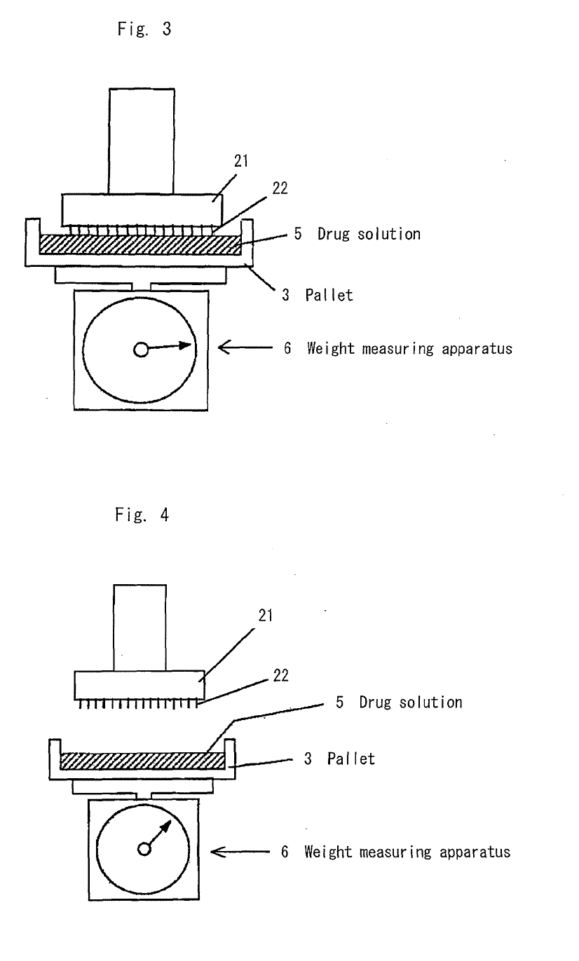

Then, the solution transfer printing apparatus 2 is moved down by the Z-axis driving mechanism 24, so that the needle members 22 are immersed in the drug solution 5 so as to supply the drug solution 5 to the needle members 22 (refer to FIG. 3).

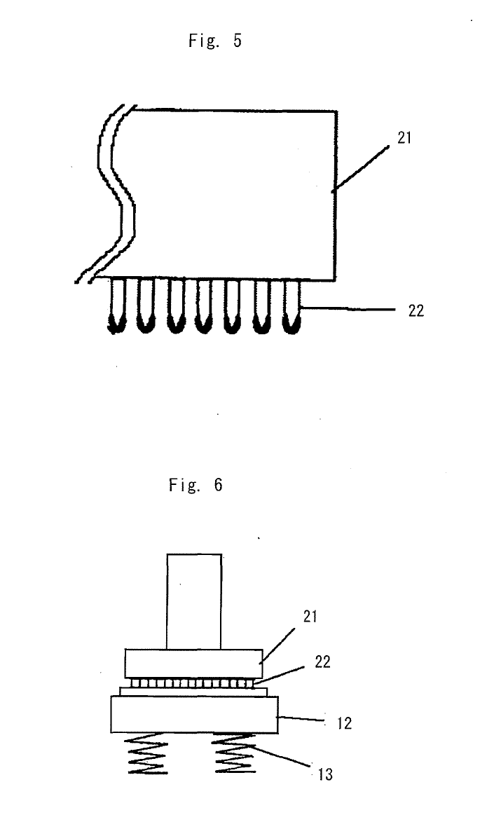

Thereafter, the solution transfer printing apparatus 2 is moved up by the Z-axis driving mechanism 24 (refer to FIG. 4). At this time, the drug solution 5 is adhered to the tip of the needle members 22 (refer to FIG. 5). Wherein, the adhesion amount of the drug solution 5 can be controlled by controlling immersing depth of the needle members 22 into the drug solution 5.

Concretely, when the weight of the drug solution 5 housed within the pallet 3 was 2510 mg when the needle members 22 were not immersed in the drug solution 5, and when the weight of the drug solution 5 housed within the pallet 3 was 2508 mg when the needle members 22 were moved up from the drug solution 5, it is understood that the drug solution 5 of 2 mg was supplied to the solution transfer printing apparatus 2. And when a total number of the needle members 22 is 2500, it is understood that the drug solution of 0.8 μg per one needle member was supplied.

Those series of weight measurements can be suppressed the affection due to variation by employing an average value obtained by repetitively carrying out the weight measurements by several number of times.

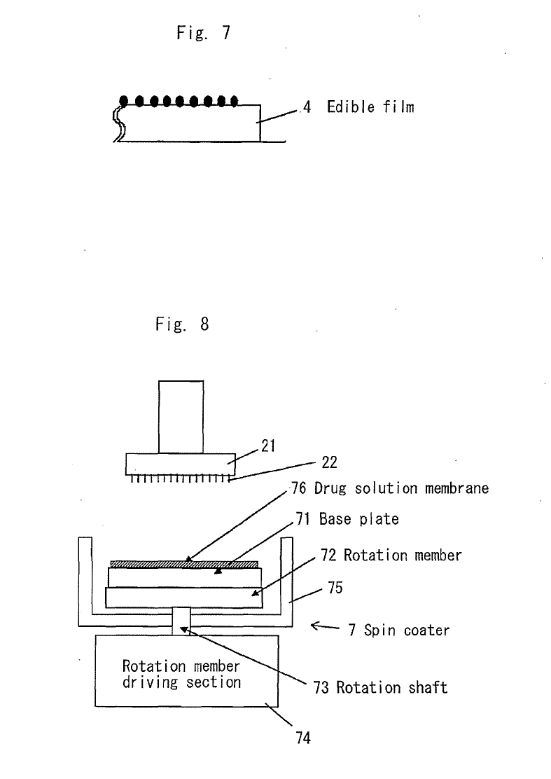

Thereafter, the solution transfer printing apparatus 2 is positioned just above the edible film 4 by the X-axis driving mechanism 23 (refer to dashed line in FIG. 1), then the solution transfer printing apparatus 2 is moved down so as to forcedly press the tip of the needle members 22 to the edible film 4, so that the drug solution adhered on the tip of the needle members 22 are transfer printed to the edible film 4 (refer to FIG. 6). Wherein, the supporting member 12 is elastically supported above the base member 11 by the elastically supporting member 13, consequently the edible film 4 is elastically supported. Therefore, the tip of every needle member 22 is almost uniformly pressed to the edible film 4, so that transfer printing of the drug solution 5 is realized without hindrance. After that, the drug solution 5 are remained on the edible film 4 in a dotted pattern, by moving the solution transfer printing apparatus 2 up (refer to FIG. 7).

Then, the above series of processing is carried out with the drug solution which has changed, so that a laminated microcapsule sheet is produced in which multiple types of materials are laminated at multiple parts on the edible film 4.

Controlling of the amount of the drug solution 5 for transfer printing on the edible film 4, is described. When a relational expression described later is obtained for carrying out the controlling, not only the weight of the pallet 3 is measured, but also the weight of the edible film 4 is measured.

As to the amount of the drug solution 5 transfer printed to the edible film 4, the weight (W2) per one dot of drug solution (the amount of the drug solution transfer printed by one needle member 22) is obtained from the difference between the weight measurement value of the edible film 4 which is prior to the transfer printing of the drug solution 5, and the weight measurement value of the edible film 4 which is after the transfer printing of the drug solution 5.

The weight of the drug solution 5 transfer printed to the needle members 22 is changed by changing the immersed depth of the needle members 22 into the drug solution 5, and the weight of the drug solution by one dot which is transfer printed to the edible film 4 is measured, and thereby the relationship between the weight (W1) of the drug solution 5 which has transfer printed to the needle member 22 and the weight (W2) of the drug solution by one dot which has transfer printed to the edible film 4, is obtained.

Further, the depth (D) of the needle member 22 immersed in the drug solution 5 is changed, and the weight (W1) of the drug solution transfer printed to one needle member 22 is measured, and thereby the relationship between the immersing depth (D) of the needle member 22 and the transfer printed weight (W1) of the drug solution to the needle member 22, is obtained.

The relationship between the immersing depth (D) of the needle member 22 and the weight (W2) per one dot of drug solution transfer printed to the edible film 4 is obtained from the relationship (preferably, relational expression) between the weight (W1) of the drug solution 5 which has transfer printed to the needle member 22 and the weight (W2) of the drug solution by one dot which has transfer printed to the edible film 4, and the relationship (preferably, relational expression) between the immersing depth (D) of the needle member 22 and the transfer printed weight (W1) of the drug solution to the needle member 22. Therefore, the weight (W2) per one dot of drug solution transfer printed to the edible film 4 can be controlled by controlling the immersing depth (D) of the needle member 22.

When the immersing depth (D) of the needle member 22 is controlled, it is possible that solution level control is carried out for determining the solution level of the drug solution 5 to be a predetermined level. It is also possible that the solution level of the drug solution 5 housed within the concave section of the pallet 3 is detected, without carrying out the solution level controlling, and that the tip of the needle member 22 is positioned corresponding to the detection result, and that the moving down distance of the needle member 22 from this position, is controlled.

Each relationship described above becomes a linear function, a quadratic function, or an N-th function (N is an integer equal to or greater than 3) depending upon the shape of the needle member 22. But, the weight (W2) per one dot of drug solution transfer printed to the edible film 4 can be controlled with accuracy and with good reproducibility, by understanding each relationship in advance by carrying out the above processing.

When the drug solution is changed, it is sufficient that a relational expression is obtained on a case-by-case basis.

The weight of the pallet 3 is measured in the above embodiment, the weight of the edible film holding apparatus 1 may be measured instead, or the weight of the solution transfer printing apparatus 2 may be measured instead.

FIG. 8 is a schematic view illustrating an arrangement of a spin coater 7 which is provided instead the pallet 3 illustrated in FIG. 1.

The spin coater 7 has a rotation member 72 for supporting a base plate 71, a rotation member driving section 74 for rotating the rotation member 72 by the intermediary of a rotation shaft 73, and a casing 75 for closing the base plate 71 and the rotation member 72 in.

The operation of the apparatus for production of the laminated microcapsule sheet is as follows, the apparatus being provided the spin coater 7 instead the pallet 3.

An edible film 4 is supported on the supporting member 12 of the edible film holding apparatus 1, and the base plate 71 is set on the rotation member 72 of the spin coater 7. Drug solution is dropped on the base plate 71, then the rotation plate 71 is rotated, so that the dropped drug solution on the base plate 71 is wetting and expanding over the entire surface of the base plate 71, a drug solution layer 76 having a uniform thickness is formed, accordingly. Preparation processing for production of a laminated microcapsule sheet has finished, therewith.

After the preparation processing has finished, the solution transfer printing apparatus 2 is positioned just above the base plate 71 (refer to FIG. 8) by the X-axis driving mechanism 23 similarly to the case where the pallet 3 is provided.

Then, the solution transfer printing apparatus 2 is moved down by the Z-axis driving mechanism 24 so that the needle members 22 are immersed in the drug solution layer on the base plate 71. Therefore, the drug solution is transferred to the needle members 22.

After that, the solution transfer printing apparatus 2 is moved up by the Z-axis driving mechanism 24. At this time, the drug solution is adhered to the tip of the needle members 22 (refer to FIG. 5).

After that, the drug solution can be remained on the edible film 4 in a dotted pattern similarly to the case of the above embodiment which employs the pallet 3. By carrying out the above series of processing with the drug solution having changed, a laminated microcapsule sheet is produced which is produced by laminating multiple types of materials at multiple parts of the edible film 4.

When the spin coater 7 is employed, it is sufficient that no weight measuring apparatus is provided to the spin coater 7. Relationship between the number of rotations and the transfer amount is obtained, by obtaining relationship between the number of rotations of the rotation member 72 of the spin coater 7 and the thickness of the drug solution layer, and relationship between the thickness of the drug solution layer and the transfer amount to the needle members 22, using a separate weight measuring apparatus which is not illustrated. Therefore, the adhered amount of the drug solution 5 to the needle members 22 can be controlled by controlling the number of rotations.

When the spin coater is employed, the drug solution layer on the base plate 71 is formed in a thin layer shape, the shape of the needle member is not required to have a needle shape projecting from the lower face of the main body member 21. A plate formed its face to have odd shaped surface may be employed.

Material of the plate may be the material (metal, nonmetal, resin or the like) used for commonly used in printing plate, stamp or the like. Material of the plate may also be resilient rubber material such as PDMS (polydimethylsiloxane) which is a type of silicon rubber.

### INDUSTRIAL APPLICABILITY

A laminated microcapsule sheet can be produced by holding an edible film on the edible film holding means, by adhering a solution containing any of materials using the pallet or the spin coater, and by transfer printing the solution containing any of materials on the edible film using multiple needles of the solution transfer printing means.

What is claimed is:

1. An apparatus for production of a laminated microcapsule sheet which is produced by laminating multiple types of materials on multiple parts of an edible film (4), comprising;
edible film holding means (1) for holding the edible film (4);
solution transfer printing means (2) comprising multiple needles (22) for transfer printing a solution containing any of materials; and
a pallet (3) for adhering the solution containing any of materials to the solution transfer printing means (2).

2. An apparatus for production of a laminated microcapsule sheet as set forth in claim 1, further comprising weight measuring means (6) which is provided at least one on the edible film holding means (1), the solution transfer printing means (2) and the pallet (3).

3. An apparatus for production of a laminated microcapsule sheet as set forth in claim 1, wherein at least one of the solution transfer printing means (2) and the edible film holding means (1) is resiliently supported.

4. An apparatus for production of a laminated microcapsule sheet as set forth in claim 1, further comprising solution level control means for controlling the solution level of the pallet (3).

5. An apparatus for production of a laminated microcapsule sheet as set forth in claim 1, further comprising weight measuring means (6) which is provided at least one on the edible film holding means (1), the solution transfer printing means (2) and the pallet (3), solution level control means for controlling the solution level of the pallet (3), and adhesion amount control means for controlling the amount of the solution adhered to the solution transfer printing means (2) based upon a weight measurement signal output from the weight measuring means (6).

6. An apparatus for production of a laminated microcapsule sheet which is produced by laminating multiple types of materials on multiple parts of an edible film (4), comprising;
edible film holding means (1) for holding an edible film (4);
solution transfer printing means (2) comprising multiple needles (22) for transfer printing a solution containing any of materials; and
a spin coater (7) for adhering the solution containing any of materials to the solution transfer printing means (2).
